(19) United States
(12) Patent Application Publication
(10) Pub. No.: US 2022/0305302 A1
(43) Pub. Date: Sep. 29, 2022

(54) Face Mask Providing Filtered Intake and Exhaust Air

(71) Applicant: Hall Labs LLC, Provo, UT (US)

(72) Inventors: Michael Hall, Provo, UT (US); David R. Hall, Provo, UT (US); Chandler Flinders, Provo, UT (US); Prabhakar Ramaraj, Provo, UT (US); Jacob Dean, Provo, UT (US); Anthony E. Pullen, Tucson, AZ (US); Jeff Duncan, Tucson, AZ (US)

(73) Assignee: Hall Labs LLC, Provo, UT (US)

(21) Appl. No.: 17/209,215

(22) Filed: Mar. 23, 2021

(51) Int. Cl. A62B 18/02; A62B 18/00; A62B 18/08

(52) U.S. Cl. CPC A62B 18/025; A62B 18/006; A62B 18/084

(57) ABSTRACT

An air filtering mask is disclosed which includes a rigid component and a flexible component. The rigid component and the flexible component combine to form a space over a user's mouth and nostrils, to form a seal therearound and to maintain the mask in place. The mask also includes an exhaust port with an exhaust filter and an intake port with an intake filter. The mask further includes an air mover pulling exhaust air out the exhaust port, thereby drawing intake air through the intake port.

### CROSS-REFERENCE TO RELATED APPLICATIONS

This application claims priority to U.S. Provisional Patent Application No. 62/992,277 titled “Head Covering Device” filed on Mar. 20, 2020, U.S. Provisional Patent Application No. 63/053,519 titled “Head Covering Device with Negative Air Flow”, U.S. Provisional Patent Application No. 63/053,523 titled “Head Covering Device with Environmental Control”, U.S. Provisional Patent Application No. 63/053,526 titled “Head Covering Device with a Communication Component”, U.S. Provisional Patent Application No. 63/053,537 titled “Head Covering Device with Automatic Air Moving System”, U.S. Provisional Patent Application No. 63/053,542 titled “Head Covering Device with Shroud”, U.S. Provisional Patent Application No. 63/053,546 titled “Head Covering Device with Washable Filtering Fabric”, U.S. Provisional Patent Application No. 63/053,548 titled “Head Covering Device with Electromagnetic Radiation Filtering Face Shield”, U.S. Provisional Patent Application No. 63/053,552 titled “Protective Mask with Negative Air Flow” filed on Jul. 17, 2020, and U.S. Provisional Patent Application No. 63/105,830 titled “Head Covering Device” filed on Oct. 26, 2020, which are incorporated herein by reference in their entirety.

### TECHNICAL FIELD

The present disclosure relates to protective masks.

### BACKGROUND

Protective face masks (PFMs) on the market are typically designed to filter the air before it enters the nose, throat, and lungs of a user. In some instances, the face mask is designed to additionally cover the eyes of a user. The PFM may be designed to filter viruses, bacteria, noxious gases, and particulates such as dust and smog. PFMS are commonly used is industrial and medical settings. In many cases, the PFMs on the market provide a way for filtered to enter the mask but not an efficient way for air to be exhausted leading to a non-optimal breathing experience for the user. Additionally, PFMs on the market only filter air entering the mask, not when air is exhausted.

### SUMMARY

One aspect of the present invention is an air filtering mask comprising, a rigid component, a flexible component, wherein the rigid component and the flexible component combine to form a space over a user's mouth and nostrils, form a seal therearound and maintain the mask in place, an exhaust port with an exhaust filter, an intake port with an intake filter, and an air mover pulling exhaust air out the exhaust port, thereby drawing intake air through the intake port.

In another aspect of the invention, the flexible component comprises a first strap that connects to one side of the rigid component, extends behind the user's head and connects to an opposite side of the rigid component. The flexible component further comprises a second strap that connects to a top edge of the rigid component, extends over and behind the head of the user and is connected to the first strap behind the head of the user. The air mover may be a fan that is attached to the first strap and wherein the device further comprises an exhaust tube connecting the exhaust port with the air mover. The air mover maybe attached to the first strap at a point near the back of the user's head.

In a still further aspect, the air mover is a fan. The fan may also be mounted to the rigid component.

In a yet still further aspect, air filtering mask further comprises a battery to provide power to the air mover and is mounted to the rigid component.

In another aspect, the air mover is a fan that is attached to the first strap and wherein the device further comprises an exhaust tube connecting the exhaust port with the air mover.

In another aspect of the invention, the air mover is a fan that is attached to a second strap and wherein the device further comprises an exhaust tube connecting the exhaust port with the air mover. The air mover is attached to the second strap at a point near the back of the user's head.

In still another aspect, the air mover comprises two fans that operate in parallel. Each of the two fans are located on opposite sides of the mask. The rigid component may extend from over the user's eyes to below the user's mouth.

In a still further aspect, the rigid component is extended to the user's forehead to cover the user's eyes, and wherein at least the portion of the rigid component that covers the eyes is transparent. The entire rigid component may be transparent to thereby facilitate communication by facial expressions. The rigid component may further comprise an electrochromic layer that is activated by the user or a sensor to darken when the rigid component is exposed to bright light.

In a still yet further aspect, the intake filter is mounted to the rigid component. The intake filter may filter the replacement air so as to block at least 95% of particles 0.3 microns or larger.

In another still yet further aspect, the intake filter is located near the mouth of the user to improve acoustics within the mask and to facilitate better oral communication.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a front view of a protective face mask (PFM) with negative air flow with an exhaust tube, according to an embodiment of the disclosure.

FIG. 2A is a side view of a PFM with negative air flow with an exhaust tube, according to an embodiment of the disclosure.

FIG. 2B is a side view of a PFM with positive air flow with an exhaust tube, according to an embodiment of the disclosure.

FIG. 3 is a front view of a PFM with negative air flow with a mask fan, according to an embodiment of the disclosure.

FIG. 4 is a side view of a PFM with negative air flow with a mask fan, according to an embodiment of the disclosure.

FIG. 5 is a front view of a PFM with negative air flow with a mask fan and power source, according to an embodiment of the disclosure.

FIG. 6 is a side view of a PFM with negative air flow with a mask fan and power source, according to an embodiment of the disclosure.

FIG. 7 is a front view of a PFM with negative air flow that covers the eyes, nose, and mouth, according to an embodiment of the disclosure.

FIG. 8 is a side view of a PFM with negative air flow that covers the eyes, nose, and mouth, according to an embodiment of the disclosure.

FIG. 9 is a front view of a PFM with a portion of the face shield comprising an electromagnetic radiation filtering film, according to an embodiment of the disclosure.

FIG. 10 is a view of user with a PFM that is controlled and monitored by an app on a smart device, according to an embodiment of the disclosure.

FIG. 11 shows a graphical user interface (GUI) for monitoring and controlling functions of a PFM, according to an embodiment of the disclosure.

FIG. 12 shows a graphical user interface (GUI) for monitoring biometric data of a user wearing a PFM, according to an embodiment of the disclosure.

FIG. 13 is a front view of a PFM integrated with a hard hat, according to an embodiment of the disclosure.

FIG. 14 is a side view of a PFM integrated with a hard hat, according to an embodiment of the disclosure.

### DETAILED DESCRIPTION

### Overview

Embodiments of methods, materials and processes described herein are directed towards air filtering face masks. Air filtering face masks can be used to provide a filtered air environment to a user to prevent a user from being infected with a contagious disease. Air filtering face masks may also filter the exhaust air to prevent a user from spreading a contagious disease.

Air filtering face masks disclosed herein include a rigid component and a flexible component where the rigid component and the flexible component combine to form a space over a user's mouth and nostrils, form a seal therearound and maintain the mask in place. The air filtering face masks further includes an intake filter, an exhaust filter, and an air mover pulling exhaust air out the exhaust port and drawing intake air through the intake port.

### Definitions

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “user” refers to any individual who uses a mask.

As used herein, the term “filter,” as a noun, refers to a device, typically composed of fibrous or porous materials which removes unwanted components, usually in the form of particulates, such as dust, pollen, mold, viruses, and bacteria, from air. Filters containing an adsorbent or catalyst, such as charcoal (carbon), may also remove odors and gaseous pollutants such as volatile organic compounds or ozone. Air filters are generally used in applications where air quality is important. As a verb, “filter” refers to the act of removing particles from air.

As used herein, the term “transparent” is used in its normal sense, that is the property of allowing light to pass through so that behind can be distinctly seen therethrough. The transparent components described and defined below are preferably clear, but may be tinted, in whole or in part.

As used herein, the term “polarizer” is an optical filter that lets light waves of a specific polarization pass through while blocking light waves of other polarizations. A polarizer can filter a beam of light of undefined or mixed polarization into a beam of well-defined polarization, that is polarized light.

As used herein, the term “photochromic” refers to a device or system where the optical properties change on exposure to light having a predetermined property, most commonly ultraviolet (UV) radiation. Most commonly, an optical lens changes from an optically transparent state to a darkened state upon exposure to UV radiation. When the UV radiation is removed, the lens returns to a clear state.

As used herein, the term “electrochromic” is where optical properties such as optical transmission, absorption, reflectance and/or emittance can be controlled in a reversible manner upon, application of an electrical energy, such as a voltage bias.

As used herein, the term “thermoelectric cooler” refers to cooling devices that operate on the principle of the Peltier effect. A thermoelectric cooler may also be used for temperature control for both heating and cooling depending upon how it is arranged in a device.

### Exemplary Embodiments

The present disclosure relates to masks and other mouth and nose-covering devices to provide a controlled and comfortable environment to a user. Users may need a controlled environment due to various health-related reasons such as to protect those with respiratory ailments, compromised immune systems, advanced age, from airborne contagion. The same protection may also be needed for the protection of health care providers. Alternatively, such devices may be desirable to use in harsh environments, such as extreme cold or heat, or environments with high levels of suspended particulate, such as dust. The present disclosure illustrates embodiments of masks that include filters and an air mover.

In various exemplary embodiments, the mask includes an air intake filter component designed to provide clean air to a user. Exhaled air from a user may be exhausted through an exhaust port. An air mover pulls the air from inside the mask and exhausts it to the environment in a negative flow mode. The exhaust air is filtered in instances where the user is infected with a disease but wishes to go out in public.

In other embodiments, an air mover pulls replacement air from outside of the device into the device through an air intake filter and the air inside the device is pushed out of the device through an exhaust filter in a positive air flow mode.

In various exemplary embodiments, the mask covers the eyes, mouth, and nose areas of a user. In other various exemplary embodiments, the mask only covers the mouth and nose area of a user.

Protective Face Mask with Negative Air Flow

The following paragraphs illustrate and describe protective face mask device designs with negative air flow to provide a controlled and comfortable environment for a user. These devices provide a negative air flow environment to a user but instead only cover a portion of the face or head of the user. In general, the PFM described herein is an air filtering mask comprising a rigid component, such as a face mask, a flexible component such as one or more straps, wherein the rigid component and the flexible component combine to form a space over a user's mouth and nostrils to form a seal therearound and maintain the mask in place. The mask further comprises an exhaust port with an exhaust filter and an intake port with an intake filter. An air mover pushes exhaust air out the exhaust port, thereby drawing intake air through the intake port.

The term “negative air flow” is used to indicate that, in accordance with embodiments of the invention, air is actively exhausted from inside the PFM by the air mover. The negative pressure thus created by the active exhaust serves to draw air into the PFM through a filter. As a result of this design, the intake air can be drawn into the device from a large surface. Consequently, the intake air can be a gentler stream of air, as compared to the stream of air if an air mover were pushing the intake air into the device. This gentler stream is believed to improve the comfort of the preferred embodiments of the invention.

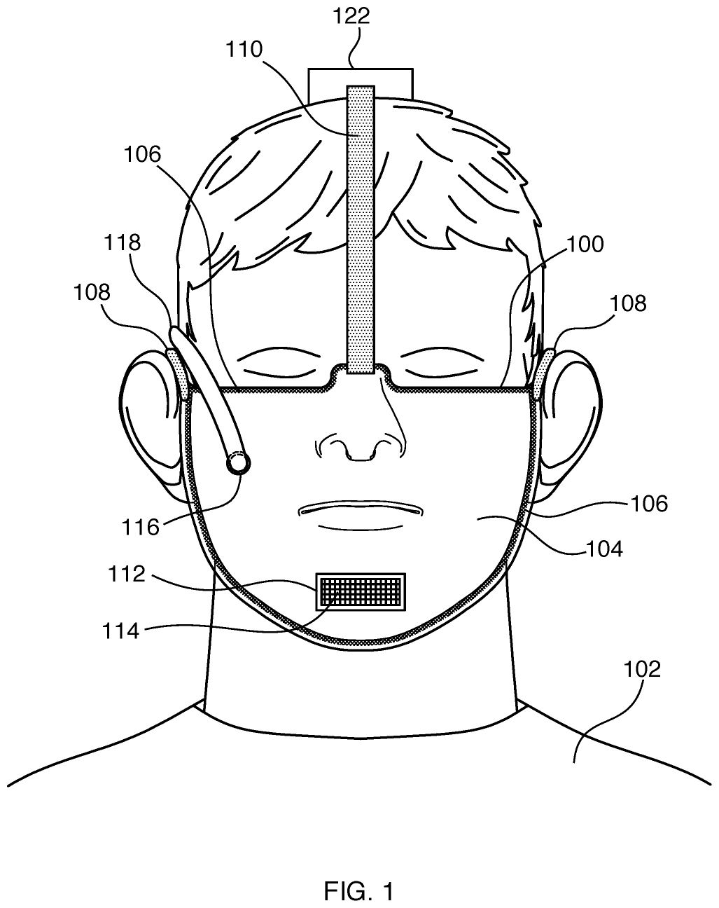

FIG. 1 is a front view of a protective face mask (PFM) 100 with negative air flow with an exhaust tube, according to an embodiment of the disclosure. Protective face mask (PFM) 100 on user 102 comprises a rigid face shield 104 that can seal the perimeter of the face shield to the face of a user. Face shield 104 may seal to the face, neck, bridge of the nose, chin, or under the chin of a user. The face shield further comprises a sealing layer 106. The sealing layer aids in sealing the face shield to the facial area of a user. The sealing layer may be a cloth, rubber, silicone, or other plastic-like material that is flexible and compressible and able to prevent air flow from passing between the face shield and the skin of a user.

There is a gap between the rigid face shield and face of the user to allow for optimal air flow and circulation. The face shield 104 can be transparent but also translucent, tinted, opaque or any combination thereof. The face shield may be comprised of a polymer or glass. The polymer may comprise an acrylic such as polymethylmethacrylate. The polymer may comprise polystyrene (PS), polycarbonate, glycol modified polyethylene terephthalate (PETG), or cellulose acetate butyrate or a combination thereof. In some embodiments, the face shield is made from a laminate of polymeric films, each contributing to the structural or optical properties of the face shield. As an example, one layer of the laminate may be included to provide shatter resistance. The face shield may be double-walled for extra insulation. A vacuum may be located between the double walls.

The face shield is preferably set close enough to the face of a user where the user's eyes are unable to focus on the inner surface of the face shield, and thus not interfere with the vision of the user.

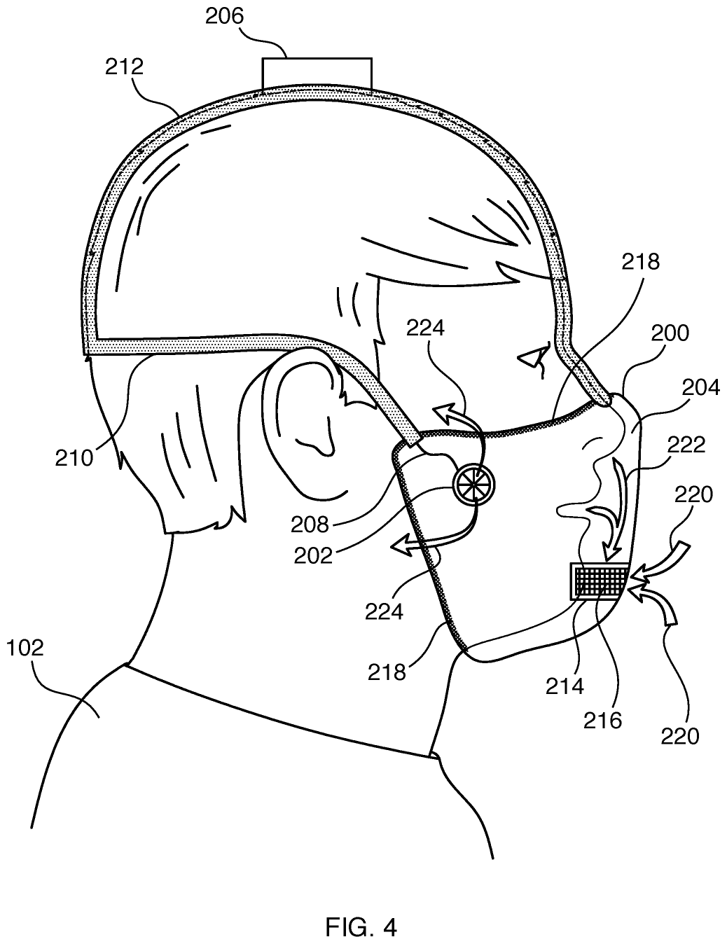

A top portion of the transparent face shield may extend above a user's eyes, a bottom portion extends below the user's mouth and a first and second side portion extend beyond the user's side peripheral vision. The top portion of face shield may extend above a user's forehead and the bottom portion extends below the user's chin. In other embodiments, the face mask may only cover the nose and mouth of the user such as PFM 200 in FIG. 4.

The face shield may have a thickness in the range of about 0.05-0.25 inches. In the depicted embodiment, the face shield 104 has a thickness of about 0.125 inches. The face shield may be constructed from materials that are approved for impact resistance by the American National Standards Institute (ANSI). The face shield may be double-walled, preferably with a vacuum therebetween, for extra insulation. The face shield may comprise a scratch resistant coating or layer on the inner and/or outer surface. The face shield may comprise an anti-fogging coating on the inner or outer surface. A replaceable protective layer may be placed over the outer surface of the face shield. Naturally, the replaceable protective layer should comprise a transparent polymer.

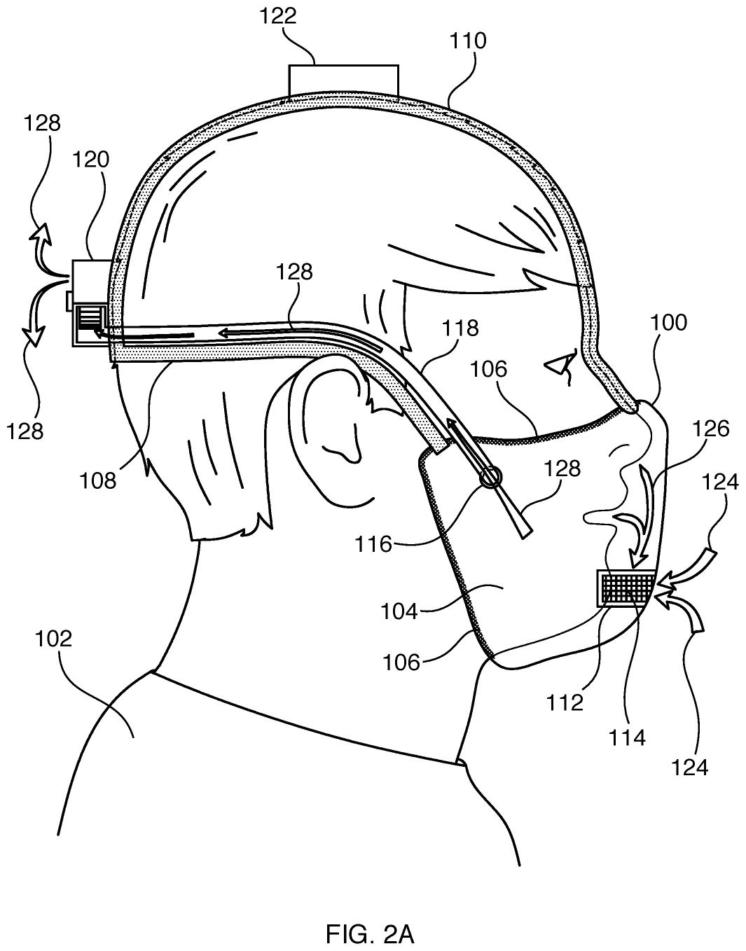

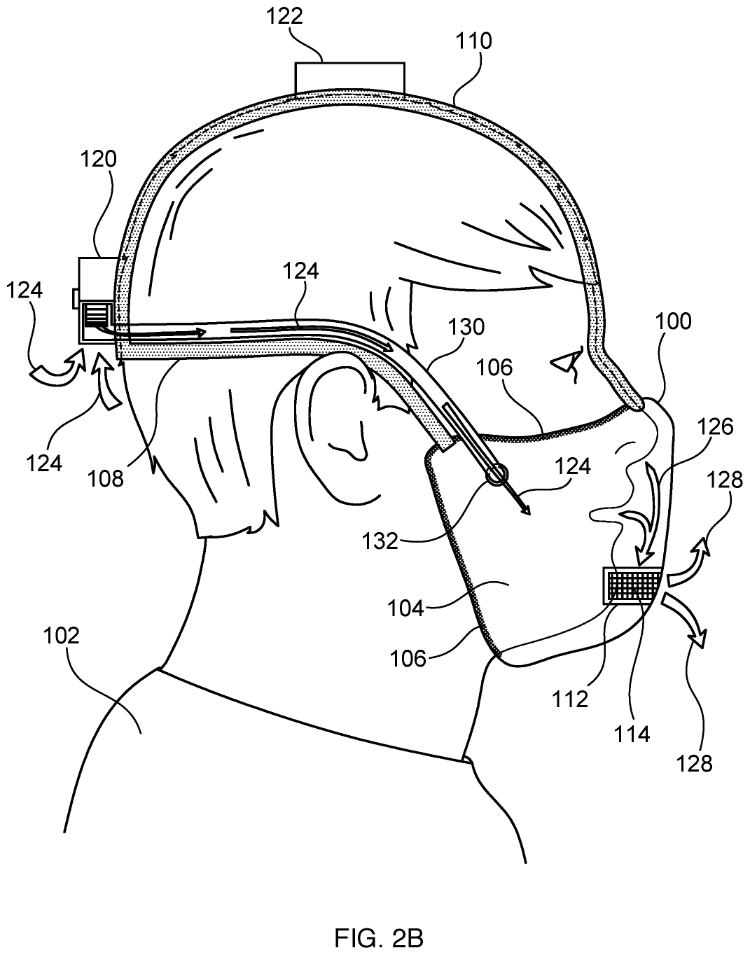

PFM 100 comprises a first strap 108. The first strap is linked to the corner of face shield wherein the first strap goes over the ears of the user towards the back of the head of the user. In some embodiments the first strap 108 may go under the ear. The PFM further comprises a second strap 110. The second strap is linked to the top of face shield 106 and above the nose of the user. The second strap goes over the top of the head of the user. The PFM may comprise one or more additional straps. The straps are to secure the PFM to the face of the user. The straps may be stretchable or non-stretchable material. The straps may be conjoined in the back of the head of the user. In some embodiments, there may be no strap that goes over the top of the head as shown in FIGS. 1-2. In some embodiments, there may be a strap that goes under the ear and towards the back of the head of the user. The straps may comprise a device to control the tightness of the PFM on the head of a user.

PFM 100 further comprises an air inlet port 112. Air inlet port further comprises an inlet filter 114. The inlet filter comprises a material to filter particulates such as viruses (e.g., SARS-CoV-2), bacteria, dust, wood or silica dust, or pollen, and may be comprised of any of the filters (i.e., N95) previously described herein. In a preferred embodiment, the inlet filter is located near the mouth area of the user. This location of the filter near the mouth improves the acoustics and oral communication of a user with others. The filter may be made from cotton, foam, paper, or stainless steel. The filter may be a coarse filter, fine filter, semi-HEPA (high efficiency particulate air) filter, HEPA filter, or an ultra-low particulate air (ULPA) filter. The filter may be a combination hydrogen fluoride and hydrogen chloride filter. The filter may be a UV filter or ultrasonic filter to clean and purify the exiting air stream. Alternatively, the filter may be enhanced with electrostatic filtering or water filtering of the air. The air exhaust filter may block at least 95% of particles 0.3 microns or larger (N95) or at least 99.95% of particles 0.3 microns or larger (N99) or at least 99.97% of particles 0.3 microns or larger (N100). The filter may be replaceable if clogged, damaged, etc.

In some embodiments, the air inlet port comprises an ultra-violet (UV) light emitting diode (LED). The UV-LED is to disinfect the air to remove viruses or bacteria that enters the air inlet port. In a preferred embodiment, the UV LED is a UV-C emitting LED that emits light with a wavelength in the range of about 200-280 nm.

PFM 100 further comprises a mask exhaust port 116. The mask exhaust port allows air to flow out of the mask. In some embodiments, an additional filter may be inserted into the mask exhaust port. This is to filter the exiting air in the event the user is sick to prevent the spread of contagion if the user has a sickness.

PFM 100 further comprises an air exhaust tube 118. The air exhaust tube is joined with the mask exhaust port 116 such that when air passes out of the mask exhaust port, the air is directed away from the face of the user. For example, the air exhaust tube may direct the air to the back of the head of the user to prevent the same air from being drawn back into the PFM 100. The air exhaust tube may be constructed of a polymer and may be transparent, opaque, or any other color. The air exhaust tube may be constructed of silicone, latex, or a thermoplastic rubber. The tube may comprise an elastomeric polymer such as polychloroprene, polyisoprene, polybutadiene, butyl rubber, nitrile rubber, or a fluoroelastomer such as Viton™.

FIG. 2A is a side view of a PFM 100 with negative air flow with an exhaust tube, according to an embodiment of the disclosure. The PFM further comprises an air moving device 120 at the back of the head of the user. FIG. 2A illustrates a fan as the air moving device. The fan may be an axial or radial centrifugal fan. The fan may be attached to the first strap 108 or second strap 110 or a point where the first and second strap meet. This could be at the back or top of the head of the user. The air moving device comprises an air exhaust port and is powered by a power source 122. In a preferred embodiment, the power source is a battery pack comprising one or more batteries such as a lithium ion battery, nickel cadmium battery, or a nickel metal hydride battery. The battery pack preferably comprises rechargeable batteries. The batteries may be charged by a cord connected to a wall outlet or by a solar cell. Preferably, a solar cell is mounted to the PFM. The solar cell may provide about 2-6 W of power. In a preferred embodiment, the solar cell may be about 6×6 in² and provide about 5 W of power to recharge the battery and thus power the components of the PFM. The power source may also be a solar cell where the solar cell may be mounted on the mask. The air moving device is connected to the exhaust tube wherein the air moving device, air exhaust tube 118, and air inlet port 112 are in fluidic communication. The fan may be removable to replace the batteries or if the fan is damaged, breaks down, loses efficiency, etc. The fan may be dual speed or other variable speed fan. The speed may be controlled by the user of the PFM. The fan may be capable of delivering more than about 1 cfm of air. The fan may be capable of delivering about 1-10 cfm of air. The fan may run intermittently with feedback to deliver a desired amount of air to the user and to keep the air fresh inside the PFM. The PFM may comprise an air flow sensor or an air pressure sensor to monitor air flow and pressure within the PFM.

In some embodiments, the PFM may comprise one or more additional fans. The fans may be operated in parallel or series mode. The fans may be arranged in various ways. In a preferred embodiment, the fans are arranged in a manner such that it provides balanced weight to the PFM.

The negative air flow in PFM 100 is illustrated as follows. The flow of air is primarily caused by the air moving device exhausting air out of the PFM. The negative pressure thus created causes air 124 from outside the PFM to enter the PFM through the inlet port and pass through the filter 114. While the primary driver of the air flow is the air moving device, the pressure created by the user's inhalation may also contribute. The air moving device draws the air inside the PFM and the exhaled air 126 into mask exhaust port 116. The exhausted air 128 may then pass through the air exhaust tube 118 towards the fan air mover where the air is exhausted to the environment.

FIG. 2B is a side view of a PFM 100 with positive air flow with an exhaust tube, according to an embodiment of the disclosure. PFM 100 and any of the other PFM embodiments described herein may also operate in positive air flow mode. The positive air flow in PFM 100 is illustrated as follows. The flow of air is primarily caused by the air moving device 120 pulling air into the PFM. The positive pressure thus created causes air 124 from outside the PFM to enter the PFM through the inlet port and pass through a filter at the air mover. While the primary driver of the air flow is the air moving device, the pressure created by the user's inhalation may also contribute. The air moving device pushes the air 124 inside the PFM through an air intake tube 130 and through a mask intake port 132. Air inside the PFM is pushed out as exhausted air 128 through the filter 114 near the mouth of the user 102.

It should be known that any of the PFM embodiments disclosed herein may also operate in neutral mode. In neutral mode, the flow of the air coming into and out of the PFM is controlled by the breathing of the user.

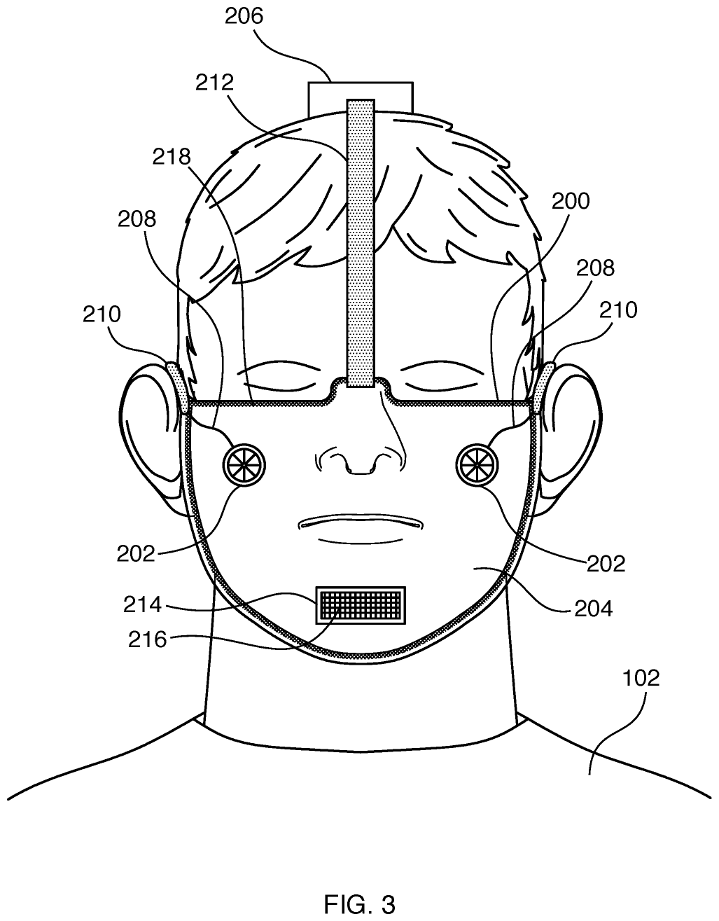

FIG. 3 is a front view of a PFM 200 with negative air flow with a mask fan, according to an embodiment of the disclosure. PFM 200 is similar to PFM 100 but with a few differences. The air moving device 202 in PFM 200 is mounted to the rigid face shield 204. The air moving devices, shown as a fan in FIGS. 3-4, are in electrical communication with a power source 206 by one or more wires 208. The wires can be hidden from view as part of one or both of straps 210, 212. Though FIG. 3 illustrates two fans mounted in the face shield, only one fan or more than two fans may be used. PFM 200 further comprises an air inlet port 214, inlet filter 216 and sealing component 218 to seal the mask to the facial area of a user.

FIG. 4 is a side view of PFM 200 with negative air flow with a mask fan, according to an embodiment of the disclosure. This view illustrates the negative air flow in the PFM 200. The negative pressure created by the exhaust fans, causes air 220 from outside PFM 200 to enter the PFM through inlet port 214 and pass through the filter 216. As with the other embodiments, the air is primarily drawn into the PFM 200 by the air moving device 202, although the inhalation of the user may also contribute. The air moving device draws the air inside the PFM 200 and the exhaled air 222 towards the air moving device. The exhaust air 224 may then pass through the air moving device where the exhaust air is exhausted to the environment.

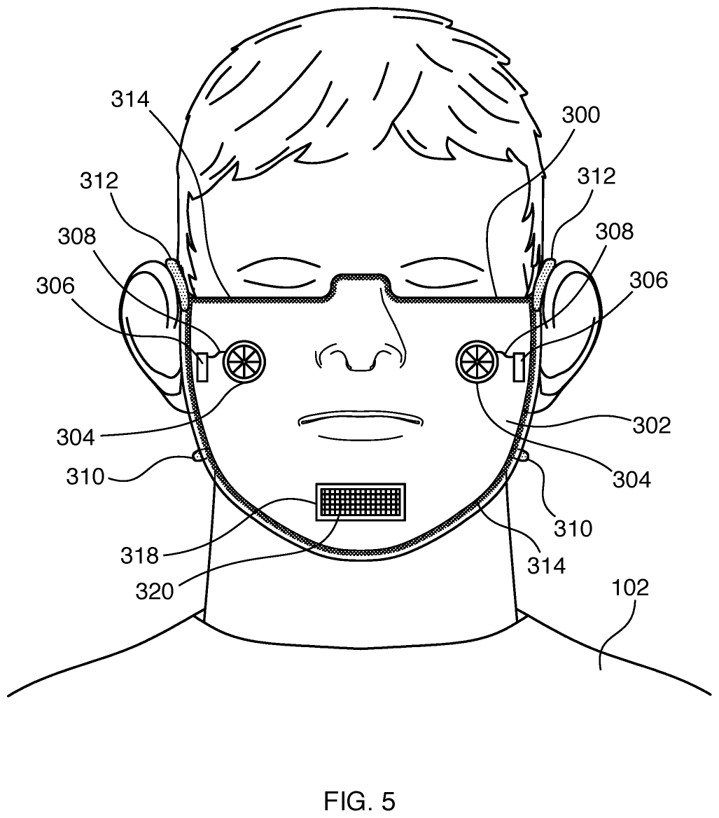

FIG. 5 is a front view of a PFM 300 with negative air flow with a mask fan and power source, according to an embodiment of the disclosure. PFM 300 is similar to PFM 200 in FIGS. 3-4 but with a few differences. PFM 300 does not include a strap that goes over the head of the user 102 nor does it have a power source located away from the face shield 302. PFM 300 comprises air moving devices 304 mounted in the face shield 302 along with the power source 306 mounted in the face shield. The power source may be a battery pack or a solar cell or a combination of both. The air moving devices and power sources are in electrical communication by one or more wires 308.

PFM 300 further comprises an additional strap 310 to top strap 312 that goes over the ears. The additional strap is linked to one side of the face shield, wraps around the back of the head under the ears of the user and is linked to the other side of the face shield.

PFM 300 further comprises a sealing component 314, such as a rubber gasket, to seal the face shield to the facial area of a user.

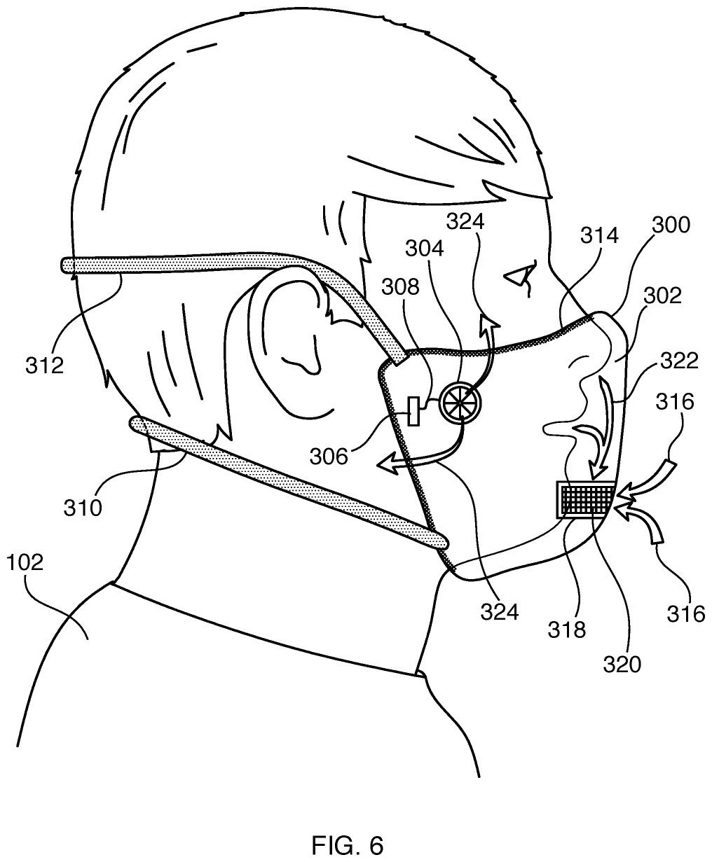

FIG. 6 is a side view of a PFM 300 with negative air flow with a mask fan and power source, according to an embodiment of the disclosure. The view in FIG. 6 illustrates the negative air flow in the PFM 300. Air 316 from outside PFM 300 may enter the PFM through inlet port 318 and pass through the filter 320. The air may be drawn into PFM 300 by way of the air moving device 304 or the inhale from the user. The air moving device may further draw the air inside the PFM 300 along with exhaled air 322 from a user towards the air moving device. The exhaust air 324 may then pass through the air moving device where the exhaust air is exhausted to the environment.

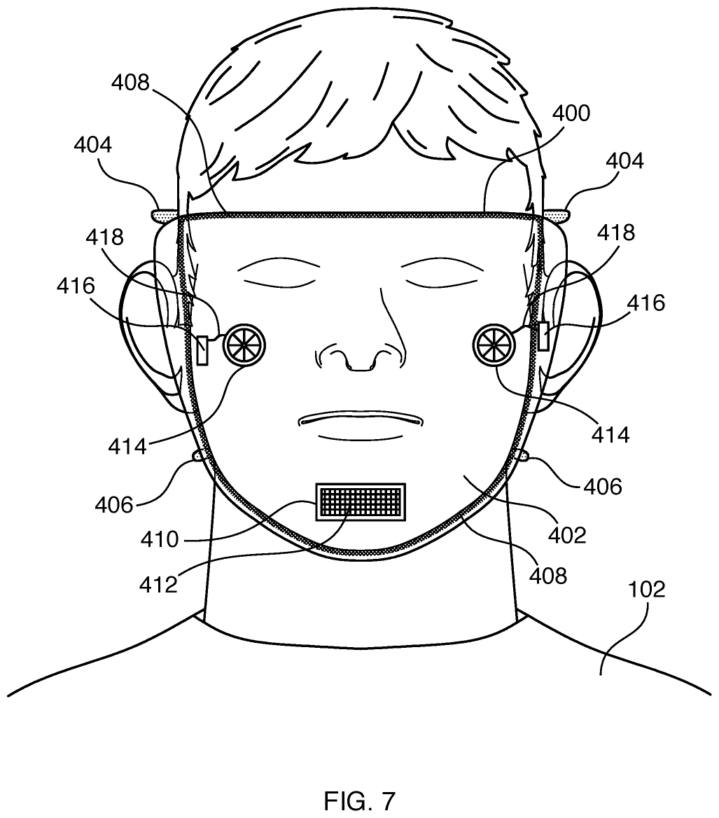

FIG. 7 is a front view of a PFM 400 with negative air flow that covers the eyes, nose, and mouth, according to an embodiment of the disclosure. The protective face mask (PFM) 400 embodiment in view FIG. 7 covers the nose, mouth, and eyes. Such an embodiment may be desirable for applications where it is important to protect the user's eyes, for example in a healthcare or industrial setting. The PFM 400 comprises a face shield 402. PFM 400 is sealed to the facial area above the eyes of the user and extends to below the chin area of the user. An air gap exists between the face shield and the face of the user. PFM 400 may comprise an anti-fogging layer on the inward surface of the face shield and a scratch resistant layer on the outward surface of the face shield.

Face shield 402 is held to the face of a user by a first strap 404 that is attached to one side of the face shield, wraps around the back of the head and over the ears of the user and attaches to the other side of the face shield. Face shield 402 is additionally held to the face of the user by a second strap 406 that is attached to one side of the face shield, wraps around the back of the head and under the ears of the user and attaches to the other side of the face shield. In some embodiments, only one strap may be used. In other embodiments, a strap may be attached at the top of the face shield and pass over the top of the head of the user as shown in FIGS. 1-2. PFM 400 further comprises a sealing component 408, such as a rubber gasket, to seal the face shield to the facial area of a user.

PFM 400 further comprises an air inlet port 410, inlet filter 412, air moving device 414 mounted in the face shield 402, power source 416 mounted in the face shield 402, and electrical wire 418 for electrical communication between the air moving device and the power source.

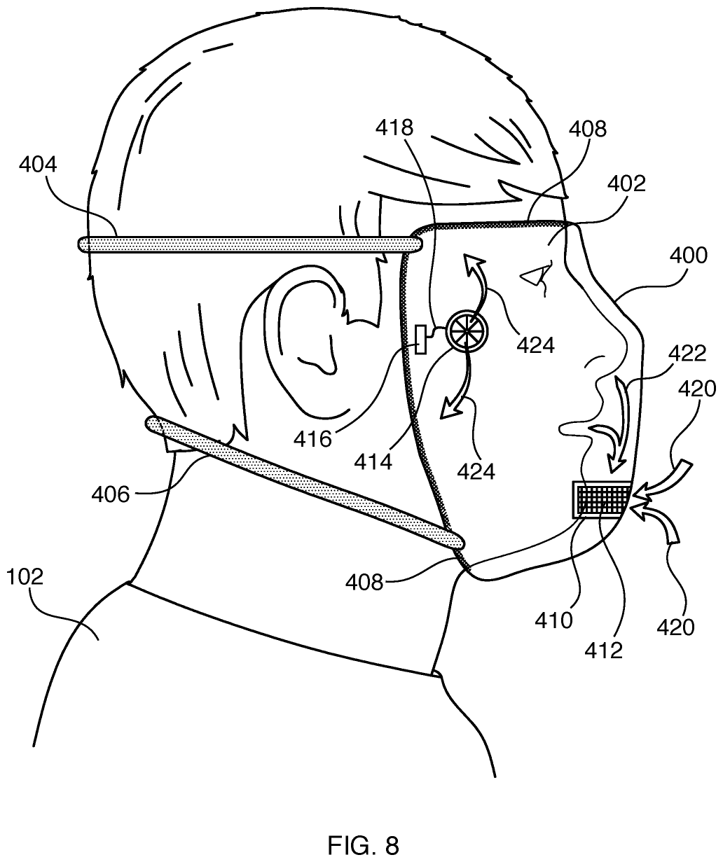

FIG. 8 is a side view of a PFM 400 with negative air flow that covers the eyes, nose, and mouth, according to an embodiment of the disclosure. The view in FIG. 8 illustrates how the straps 404, 406 wrap around the head of the user to secure PFM 400 to the facial region of the user.

FIG. 8 further illustrates the negative air flow in PFM 400. By virtue of the negative pressure created by the air moving device 414, air 420 from outside PFM 400 is drawn into the PFM through inlet port 410 and pass through the inlet filter 412. The air is primarily drawn into the PFM by way of the air moving device 414 pulling in air but may be assisted by the inhale of the user. The air mover pulls the air inside PFM 400 and the exhaled air 422 out of PFM 400. The exhaust air 424 then passes through the air moving device where the exhaust air is exhausted to the environment.

In some embodiments, PFM 400 may instead comprise a power source or air moving device that is not mounted to the face shield. Instead, the air moving device and power source may be located on top or the back of the head of a user as shown in FIGS. 1-2. An exhaust tube and exhaust port may be added to the PFM 400 to fluidically communicate the inlet port with the air moving device.

### Automatic Air Moving System

In some embodiments, a PFM may comprise an air moving system that automatically starts when a user places the mask on and turns off when the user removes the mask. A spring-loaded lever switch may be located under the fan or under the power source or other location. A lever may protrude outward such that when it is depressed, it retracts when a user places the mask on. Preferably, the user cannot feel the lever. By depressing the lever, the switch completes an electrical circuit such that power from the power source provides an electrical current to an air moving device, such as a fan 414 shown in FIGS. 7-8. The air moving system then automatically turns on. When a user removes the mask, the lever is extended by a spring which breaks the electrical circuit between the air moving device and power source which automatically shuts down the air moving device.

Any of the PFM embodiments described herein may comprise one or more sensors. The sensor can detect the head of a user and sends a signal to turn on the air moving system. The sensor may be a temperature sensor, pulse rate sensor, IR sensor, optical sensor, humidity sensor, proximity sensor, motion sensor, skin moisture sensor, force sensor, or a biometric sensor. Upon detection of the head of the user placing the PFM on, the automatic air moving system turns on. This may be done by measuring the temperature of a user or a proximity sensor of a nearby object, such as the head of a user. When the PFM is removed, the sensor no longer detects the head of a user and the automatic air moving system then turns off. The sensor may be located anywhere within the PFM, such as on the transparent face shield.

In some embodiments, one or more sensors may be located on the rigid or flexible portion to detect air conditions inside the PFM. The sensors may communicate to one or more air movers to increase or decrease air flow according to a pre-determined setting.

A PFM may further comprise two or more electrodes. The electrodes may be located anywhere in the device where the skin of the user comes into contact with the electrodes. By coming into contact with the electrodes, the circuit is closed and a current is able to pass. This current is detected by a sensor that initiates the starting of the automatic air moving system.

### Electromagnetic Radiation (EMR) Filtering Face Shield

The following embodiments describe designs and methods to filter electromagnetic radiation hitting the face shield from a user wearing a PFM.

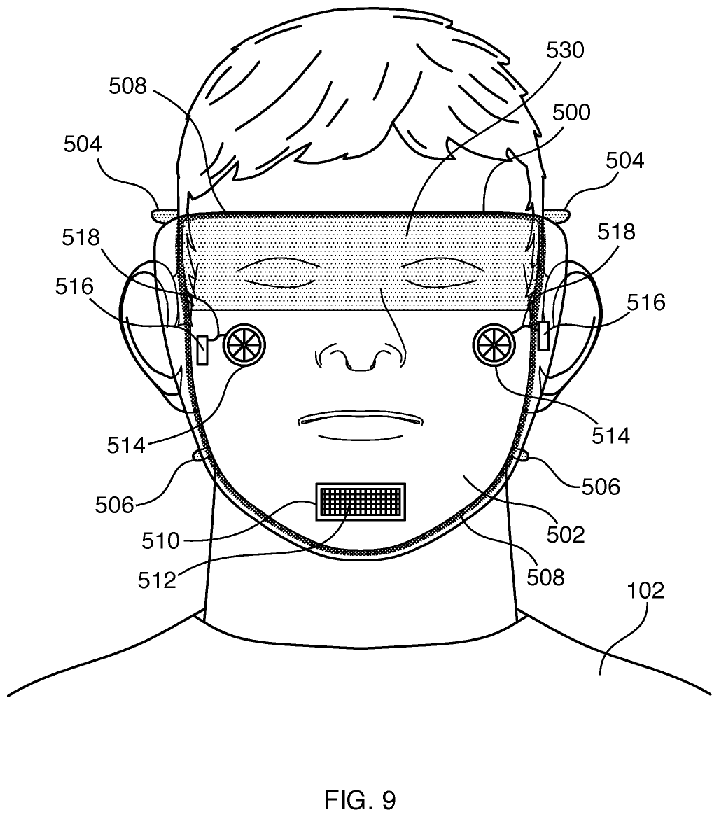

FIG. 9 is a front view of a PFM 500 with a portion of the face shield 502 comprising an electromagnetic radiation filtering layer, according to an embodiment of the disclosure. PFM 500 is similar to PFM 400 embodiment where PFM 500 comprises a face mask 502, first strap 504, second strap 506, sealing component 508, air inlet port 510, air filter 512, air moving device 514, power source 516, and electrical wire 518. FIG. 9 further shows a PFM with a portion of the transparent face shield 502 comprising an electromagnetic radiation (EMR) filtering layer 530. The EMR filtering layer 530 shown in FIG. 9 partially covers the face shield. In some embodiments, the EMR filtering layer may completely cover the face shield. The EMR filtering layer can be tuned to selectively filter one or more wavelengths or wavelength ranges of EMR, such as ultra-violet (UV), visible, or infrared (IR) radiation to dim the amount of light that enters the PFM and provides shade to the user. In a preferred embodiment, the EMR filtering layer 530 filters UV light only. In some embodiments, particularly those used for healthcare environments, or for travel, the transparent face shield may be transparent to infrared (IR) radiation to allow for determination of the temperature of a user.

In some embodiments, the EMR filtering layer may comprise a photochromic layer. The photochromic layer reversibly darkens in the presence of UV radiation, such as from sunlight. The photochromic layer reversibly darkens in the presence of UV-A light (wavelengths of 320-400 nm). The photochromic layer reversibly darkens in the presence of both UVA and UVB light. The photochromic layer comprises an inorganic material such as AgCl. The photochromic layer comprises an organic material such as an oxazine or a napthopyran-based material. The photochromic layer may comprise the material used in Transitions® lenses.

The face shield in any of the PFM embodiments disclosed herein may comprise a polarizing filter layer. The polarizing layer may be a linear polarizer or circular polarizer. The polarizing layer may be tuned to filter visible, UV, IR, radio waves, microwaves, or X-rays.

The face shield in any of the PFM embodiments disclosed herein comprises an electrochromic layer. The electrochromic layer comprises an inorganic material such as WO₃. The electrochromic layer comprises an organic material such as a conducting polymer or a viologen-based material. The conducting polymer may be a polyaniline, polythiophene, poly(3,4-ethylenedioxythiophene) (PEDOT), or a polypyrrole-based polymer or combinations thereof.

The face shield in any of the PFM embodiments disclosed herein may comprise an EMR filtration layer on the top half of the face shield. The EMR filter layer acts as a sunshade wherein a user may not need to wear a pair of sunglasses behind the face shield. Additionally, the partial EMR filtration layer helps to keep the user cool by reflecting EMR radiation from the top of the head and eyes of a user. Only blocking a portion of the light that passes through the face shield allows the PFM 500 to be used indoors.

In some embodiments, a moveable visor may be used instead of a permanent EMR filtering layer on the face shield. Such a visor can be mounted either on the inside or on the outside of the face shield. In either event, the moveable visor may be slid across the face shield. The visor is moveable and can be moved to overlap at least a portion or all of the face shield. The moveable visor may be opaque to all EMR. The moveable visor may be tuned to be opaque to only select wavelengths or ranges of wavelengths such as UV, visible, IR, X-rays, or microwaves. At least a portion of the transparent face shield is opaque to ultra-violet (UV) radiation. The moveable visor may be attached to the top of the face shield and may be slid up and down or side to side over the face shield. In other embodiments a detachable visor may be used to block specific wavelengths of light. The detachable visor may be attached and unattached with a device such as Velcro, buttons, clips, screws, or other mechanism.

### Environmental Control

The following embodiments describe systems and methods to provide a controlled temperature and breathing environment inside a PFM.

The PFM embodiments described herein further comprises at least one additional air inlet. The additional air inlet may comprise a thermoelectric cooler. The thermoelectric cooler may be designed to heat or cool incoming air. The thermoelectric cooler may be combined with a heat exchanger device to increase efficiency of heat transfer between incoming and exhaust air. The thermoelectric cooler may be used to control the temperature of the air to prevent fogging on the face shield or humidity build-up in the PFM. The inner surface of the face shield may comprise an anti-fogging layer.

The additional air inlet or other air inlet may comprise an energy recovery or heat recovery device. Such a device would heat incoming intake air with outgoing exhaust air in order to maintain a comfortable environment within a PFM described herein.

Additional air inlet or other air passage may comprise a sensor that detects one or more harmful gases as the gases enter the PFM. The harmful gases may include CO₂, CO, NOₓ, radon, or methanethiol.

A PFM described herein may further include an environmental control device that can be used by a user to control the temperature inside the PFM by raising or lowering the temperature.

A PFM described herein may further include a multi-speed air moving system. The multi-speed air moving system may be a dual speed fan. If a pre-set environmental threshold or parameter is exceeded within the PFM, such as temperature or humidity, the air mover adjusts the air flow to improve the environment by increasing or decreasing air flow within the PFM. In some embodiments, the air mover speed may be decreased until a pre-determined threshold is reached.

A PFM described herein may further include an environmental control device that can be used by a user to control the humidity inside the PFM by raising or lowering the moisture level. The environmental control component captures water vapor to lower humidity of the air inside the device.

A PFM described herein may include one or more sensors to provide filter end of useful life alerts to the user based on at least one of age of the filter, increased head pressure on the filter and optical readings indicating a dirty filter.

In some embodiments, wearable electronics may be embedded in the air moving device, or face shield or other location in the PFM to provide environmental monitoring and thermal regulation within the PFMs described herein. The wearable electronics may also monitor the vital signs of a user such as pulse rate, blood pressure, respiration, skin moisture, and body temperature. The electronics may be powered by the power source used for the air moving device or a separate power source may be used.

### Communication Component

The PFM embodiments shown in FIGS. 7-9 may further comprise a video display such as a liquid crystal display (LCD), a light emitting diode (LED) display or an electrophoretic reflective display. The display may be in the form of an optical head-mounted display (OHMD) that is mounted on the face shield such that the display is slid down over the face shield. The video display provides images for augmented reality, way-finding, GPS, maps, or environmental warnings.

The OHMD may be “smart glasses” such as Google Glass, Microsoft HoloLens, or Apple Glass. Any of the communication devices described herein may be powered by a power source mounted on the PFM as described previously herein.

The PFM may further comprise an antenna. The antenna may be used to pick up radio and other frequencies. The antenna may be coated onto the face shield or incorporated into the device in any manner.

Smart for Working with a PFM

The following embodiments describes a PFM wherein the electronic functions can be controlled and monitored by a configured smart app running on a user's smart device. The smart app may be compatible with smart devices, such as smart phones, tablets, and wearables. The smart app may also include natural language processing (NLP) capabilities to allow for hands-free device usage, greater accessibility for individuals with disabilities, convenience, and novelty. The smart app may have augmented reality capabilities. The smart app may include predictive analytics for a more personal and engaging experience based on past movements and activities. The smart app may utilize biometric data, GPS, or other sensory hardware to provide information about the user, their environment, and their location. The smart app can be downloaded onto a mobile device such as a wearable, tablet, laptop, or cell phone. The smart app can be downloaded onto a non-mobile device such as a desk top computer.

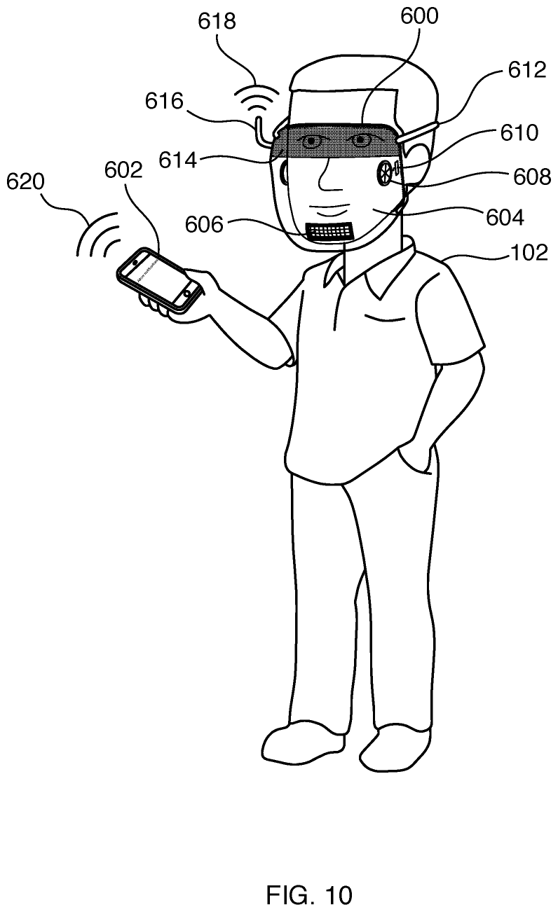

FIG. 10 is a view of user with a PFM 600 that is controlled and monitored by an app on a smart device 602, according to an embodiment of the disclosure. The PFM is similar to other PFM embodiments described herein comprising a face shield 604, air filter 606, air moving device 608, power source 610, straps to secure the PFM 612, and optional dimmable portion 614 to filter electromagnetic radiation. The PFM further comprises an antenna 616 to receive a wireless signal that is extended from the PFM. In other embodiments the antenna may be in the form of wires located on the surface of the face shield.

The PFM comprises a controller that may include one or more communication systems, including Bluetooth communication chips, Internet Wi-Fi transceivers, network transceivers, a wireless mesh network device such as Z-Wave network transceiver, or a combination thereof. The controller is able to control various components of the PFM such as the rate of the air mover, humidity level, temperature, dimming of the face shield using an electrochromic layer, audio visual and communication components such as an optical head mounted display, microphone, or speaker on demand from the user using an app on a smart device. The one or more communication systems may communicate by a wireless signal 618 with at least one of external remote controllers, such as a smart device, and a cloud-based network. The one or more communication systems may receive instructions from the external remote controller, generate signals 620 instructing components of the PFM to operate and to monitor the status of various components. The communications system may generate a signal 618 informing the external remote controller of the status of at least one device in the PFM such as the air flow rate and battery status. In an exemplary embodiment, the remote controller is a smart device such as a tablet or mobile phone 602.

The smart device communicates to a plurality of devices within the PFM. The smart device may also include a wireless transmitter and wireless transceiver and have a connection to each network device of the one or more PFM devices. The connection may include a wired or wireless interface such as Bluetooth, WIFI, mesh network or similar wireless protocol.

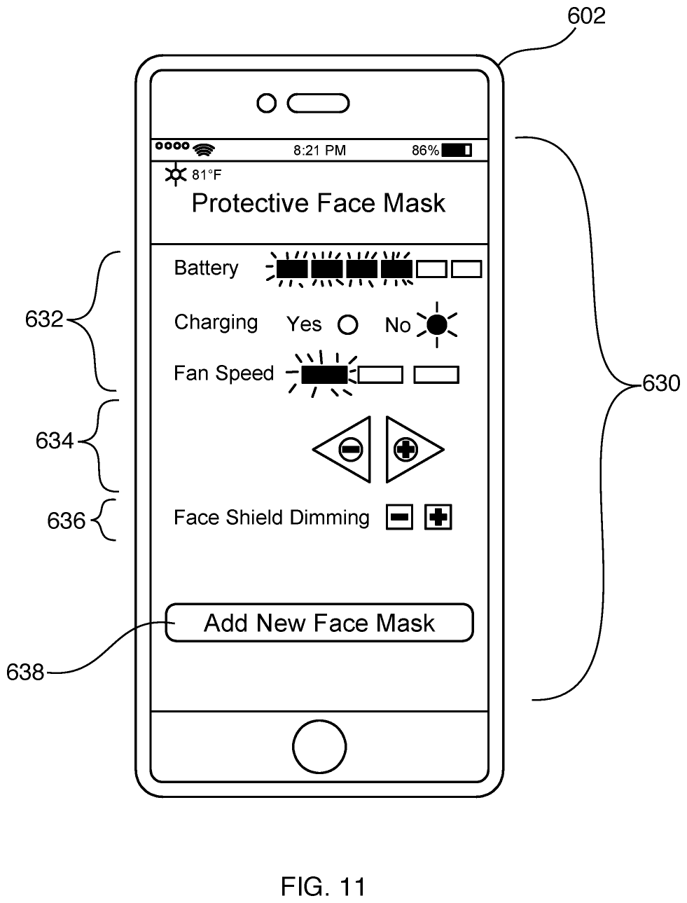

FIG. 11 shows a graphical user interface (GUI) 630 for monitoring and controlling functions of a PFM, according to an embodiment of the disclosure. FIG. 11 illustrates an exemplary GUI 630 configured to be executed on a mobile device 602. Nevertheless, in other embodiments, the application may be configured to execute on a desktop computer, workstation, tablet, laptop, or other suitable computing device.

The GUI example embodiment 630 displayed on a mobile phone 602 displays various information and multiple indicators and control functions. The name of the device “Protective Face Mask” as displayed at the top of the screen along with standard information such as the time, temperature, weather conditions, and battery charge level of the smart phone. Although the name “Protective Face Mask” is used for the name of the device for illustrative purposes, the user can give the PFM device any name. In this embodiment, the battery charge level, whether the PFM is plugged in and charging, and the variable fan speed indicators 632 are displayed. Controls for the fan speed 634 are also shown wherein touching “−” decreases the fan speed and pressing “+” increases the fan speed. Towards the bottom of the GUI the controls 636 for increasing or decreasing the amount of dimming by an optional electrochromic layer 614. The lights may be lights inside or outside of the PFM.

In some embodiments, the mobile device app may be able to monitor and control more than one PFM. At the bottom of GUI 630, a user can touch “Add New Face Mask” to add another PFM. The PFM could be added by a QR code located on the PFM or search by the name of the PFM. A Bluetooth verification method could be used to create a connection between the mobile phone device and the PFM. A QR code located on an PFM device could also be scanned to link the PFM to the mobile phone app.

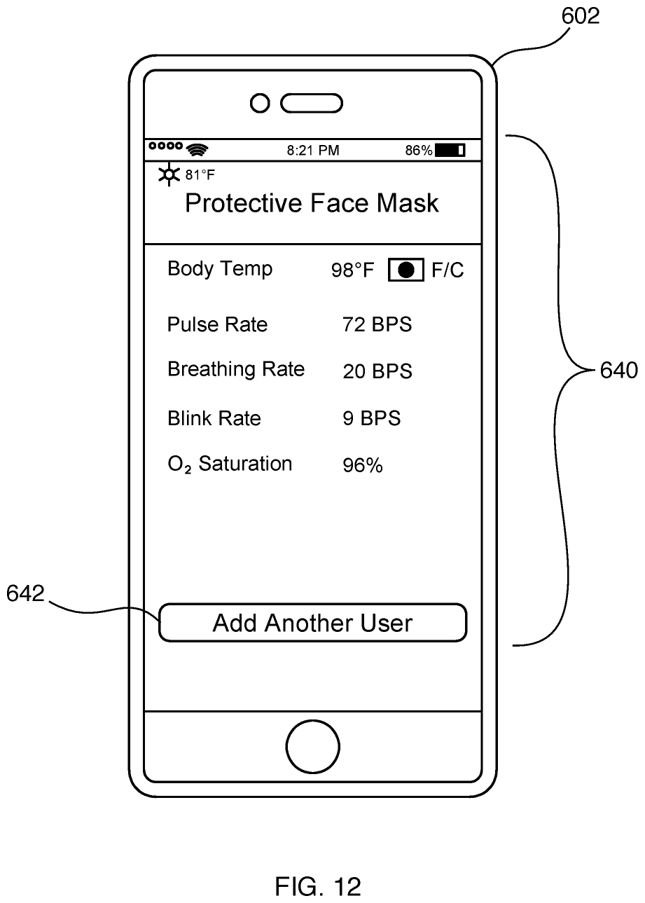

It should be known that other designs of GUIs may be used. Other controls may be monitored and controlled such as air flow and temperature. FIG. 12 shows a graphical user interface (GUI) 640 for monitoring biometric data of a user wearing a PFM, according to an embodiment of the disclosure. Biometric data such as body temp, pulse rate, breathing rate, blink rate, and oxygen (O₂) saturation levels may be collected by sensors located in various locations in the PFM. Other biometric data may be displayed. The app may be able to store and monitor the biometric data for more than one user. This can be achieved by touching “Add Another User” 642 shown at the bottom of GUI 640.

The app may provide alerts for any information collected by the PFM such as performance of the PFM itself or biometric data collected on the user. The alerts may be programmed and set by the user or may be set based on the age, weight, height, or other information of the user.

The app may receive signals from one or more sensors to test and/or monitor fitment of the system such as the detection of leaks around the seal of the rigid component to the face area of the user. The sensors may be able to detect a gas for use in testing fitment.

The app may provide alerts for information collected by safety sensors in occupational safety applications such as exterior temperature, noise level, or air quality. The app may be configured to control the temperature and air flow, volume inside of the PFM. Air pressure differences may also be monitored by one or more sensors and relayed to the smart device and displayed by the app.

In some embodiments, the app may provide audio assistance to users who are blind and cannot read the GUI. The audio assistance would read what is one the GUI to the user. The volume of the audio could be controlled for the hearing impaired. The app may be used to control video images or projections within the PFM.

The app may be configured to provide filter end of useful life alerts to the user based on at least one of age of the filter, increased head pressure on the filter and optical readings indicating a dirty filter.

### Safety Features

The following embodiments describe designs for safety features in a PFM to protect a user from harm where the risk of injury is high. The is may be in an occupational setting.

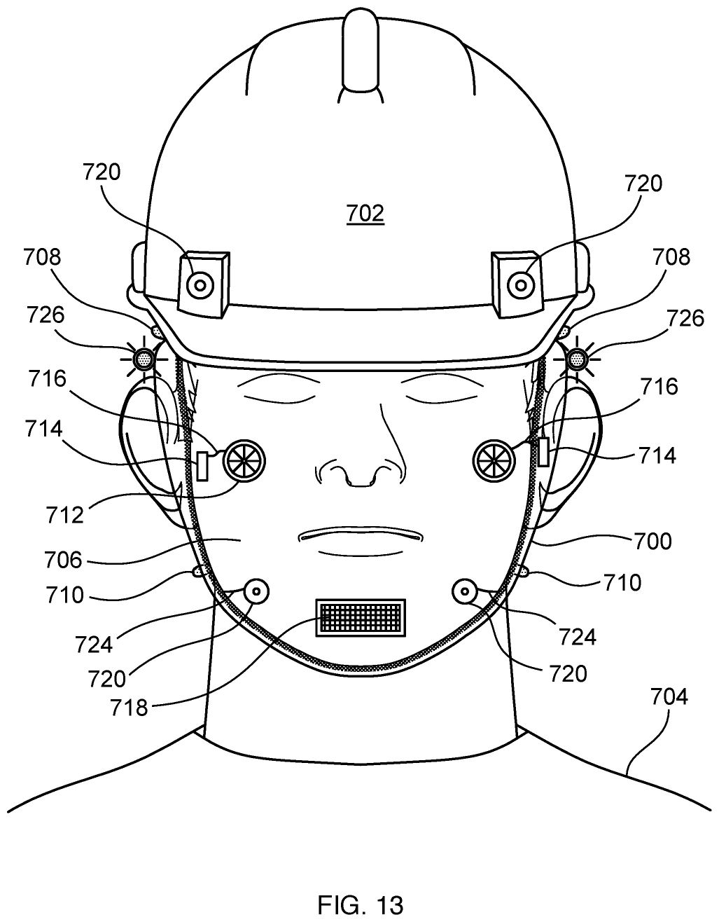

FIG. 13 is a front view of a PFM 700 integrated with a rigid top portion 702, according to an embodiment of the disclosure. The rigid top portion protects the user from falling objects. In an exemplary embodiment, the ridged top portion is a hard hat. In some instances, a user 704 may not only desire or require a controlled atmosphere or breathing environment provided by the PFM, but also further safety if the user is working in a setting where there may be hazards, such as occupational hazards. For example, the setting may be a construction site, manufacturing plant, mining site, oil rig, or a natural disaster zone.

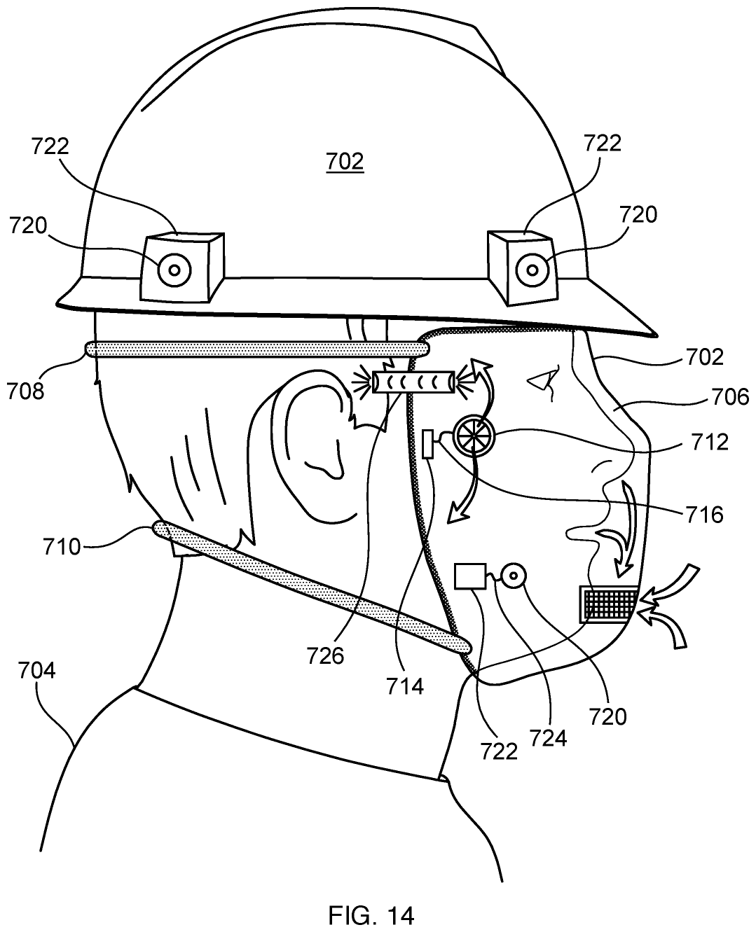

PFM 700 is similar to other PFM embodiments described herein and comprises a face shield 706, first face strap 708, second face strap 710, air moving device 712, power source 714, electrical wire 716, and filter 718. The PFM and hard hat are separate pieces as shown in FIGS. 13-14. In other embodiments, the PHM and hard hat may be joined together in such a way so that the hard hat stays in place on top of the device and does not come off. A locking mechanism may be used to secure the device and hard hat together such as snaps, screws, straps, or other mechanism. The locking mechanism may be manipulated to unjoin the hard hat and PFM reversibly. In other embodiments, the PFM and hard hat may be of unitary construction where the PFM and hard hat are one piece and only the filters, batteries, or fans may be removed to be cleaned or replaced. The hard hat may comprise a polymer or metal.

FIG. 14 is a side view of a PFM 700 integrated with a hard hat 702, according to an embodiment of the disclosure. The hard hat may be a Type I hard hat that is intended to reduce the force of impact resulting from a blow only to the top of the head. The hard hat may be a Type II hard hat that is intended to reduce the force of lateral impact resulting from a blow which may be received off-center, from the side, or to the top of the head. The hard hat may be a Class E electrical hard hat that is designed to reduce exposure to high voltage conductors and offer dielectric protection up to 20,000 volts (phase to ground). The hard hat may be a Class G general hard hat that is designed to reduce exposure to low voltage conductors and offer dielectric protection up to 2,200 volts (phase to ground). The hard hat may be a Class C hard hat. Class C conductive hard hats differ from Class E and G hard hats in that they are not intended to provide protection against contact with electrical conductors. Class C hard hats may include vented options which not only protect the wearer from impact, but also provide increased breathability through their conductive material (such as aluminum) or added ventilation.

In some embodiments, the hard hat or PFM further comprises one or more optional sensors 720. The sensors are preferably located around the perimeter of the hard hat 702 or at various locations on the PFM 700. The PFM or hard hat further comprises compartments 722 where the sensor electronics and power source are located. In some embodiments, the sensor electronics may be located inside the hard hat. The sensors may be supplied with power by an electrical wire 724.

Various types of sensors may be used. In a preferred embodiment, one or more proximity sensors are installed in the PFM/hard hat embodiment. The proximity sensors can warn a user if the user is coming into close proximity to a stationary object, or a large moveable object is approaching such as a forklift or autonomous robot, or if the user is approaching a particularly dangerous location and other scenarios. The sensors would alert the user to the danger or in some embodiments, alert the other person to halt or divert their direction. In the event a user is at risk of being hit with an object, the proximity sensor may detect the object and an inflatable personal airbag may be deployed from the PFM or hard hat to minimize any danger to the head and neck area of the user. Different types of audible signals or message may be relayed to the user depending on the type of danger present. The sensors may also be able to wirelessly relay the location information in real-time to a central database to be tracked, monitored, and recorded, such as by a site manager. If an incident does occur, the incident can be automatically tracked and recorded and relayed to and warn other users in the industrial setting of any dangers.

The PFM 700 or hard hat 702 may comprise a unique QR code. The QR code may be scanned by a scanner or cell phone which is relayed to a monitoring system that a user is entering the industrial setting. Each user may be assigned a unique QR code. Once a user places a PFM and hard hat on, the movements of the user can be tracked and warned of any impending danger. The PFM or hard hat may comprise a GPS device to track the movements of the user.

Face shield 706 may further comprise a layer of a polarizing film or an electrochromic layer, or a combination thereof, on the inner or outer surface as previously disclosed herein to filter EMR. In an exemplary embodiment, the EMR filtering layer can filter light with a wavelength range of about 200-380 nm. The film may sufficiently filter UV and infrared light so that the PFM can be safely used by welders in fusion and pressure welding processes. The film or shield may further comprise a protective layer to protect against flash burn or sparks that may occur during welding. In an exemplary embodiment, the face shield with the EMR filtering layer is American National Standards Institute (ANSI) Z87.1+ certified and compliant. The entire face shield or a portion of the face shield may be covered by an EMR film. One or more sensors may be located on the rigid portion to alert the user of exposure to bright light and to dim to activate the electrochromic layer.

For further protection for welders, the filters in the PFM may be capable of filtering welding fumes. Welding fumes typically consists of visible smoke that contains harmful metal fume and gas byproducts. Welding fumes can contain a variety of metals, including aluminum, arsenic, beryllium, lead, and manganese. Argon, nitrogen, carbon dioxide, carbon monoxide, and hydrogen fluoride gases often are produced during welding. Sensors may be combined with the PFM to specifically detect welding byproducts. The sensors would preferably be placed inside the PFM near an inlet filter to detect any welding fume ingress. The sensors could give a visual or audible warning to the user.

In some embodiments, the PFM may comprise noise reduction devices to limit the amount of occupational noise the user is exposed to in loud industrial environments and to protect the hearing ability of the user. For example, the noise reduction devices may be able to prevent the user from being exposed to noise greater than 85 decibels. The PFM may also comprise optional secondary electronic noise reduction devices. The secondary electronic noise reduction devices may be connected to a power source by one or more wires. The electronic noise reduction devices comprise optional noise cancelling earpieces adjacent to the ear canals to reduce occupational noise.

In some embodiments, the PFM comprises one or more lights 726 mounted to the face shield for a user to see in dimly lit locations, such as in a mine or at night. The lights can illuminate in a forward or rearward direction. In some embodiments, the lights may further comprise a camera. The camera may face the front, the rear, or be a front and rear facing camera.

The invention has been described with reference to various specific and preferred embodiments and techniques. Nevertheless, it is understood that many variations and modifications may be made while remaining within the spirit and scope of the invention.

What is claimed is:

1. An air filtering mask comprising:
a rigid component;
a flexible component, wherein the rigid component and the flexible component combine to form a space over a user's mouth and nostrils, form a seal therearound and maintain the mask in place;
an exhaust port with an exhaust filter;
an intake port with an intake filter; and
an air mover pulling exhaust air out the exhaust port, thereby drawing intake air through the intake port.

2. The device of claim 1, wherein the flexible component comprises a first strap that connects to one side of the rigid component, extends behind the user's head and connects to an opposite side of the rigid component.

3. The device of claim 2, wherein the flexible component further comprises a second strap that connects to a top edge of the rigid component, extends over and behind the head of the user and is connected to the first strap behind the head of the user.

4. The device of claim 1, wherein the air mover is a fan.

5. The device of claim 4, wherein the fan is mounted to the rigid component.

6. The device of claim 1, further comprising a battery to provide power to the air mover and is mounted to the rigid component.

7. The device of claim 2, wherein the air mover is a fan that is attached to the first strap and wherein the device further comprises an exhaust tube connecting the exhaust port with the air mover.

8. The device of claim 7, wherein the air mover is attached to the first strap at a point near the back of the user's head.

9. The device of claim 3, wherein the air mover is a fan that is attached to the second strap and wherein the device further comprises an exhaust tube connecting the exhaust port with the air mover.

10. The device of claim 9, wherein the air mover is attached to the second strap at a point near the back of the user's head.

11. The device of claim 9, wherein the air mover is attached to the second strap at a point near the top of the user's head.

12. The device of claim 1, wherein the air mover comprises two fans that operate in parallel.

13. The device of claim 12, wherein each of the two fans are located on opposite sides of the mask.

14. The device of claim 1, wherein the rigid component is extended to the user's forehead to cover the user's eyes, and wherein at least the portion of the rigid component that covers the eyes is transparent.

15. The device of claim 14, wherein the entire rigid component is transparent to thereby facilitate communication by facial expressions.

16. The device of claim 12, wherein the rigid component extends from over the user's eyes to below the user's mouth.

17. The device of claim 14, further comprising an electrochromic layer that is activated by the user or a sensor to darken when the rigid component is exposed to bright light.

18. The device of claim 1, wherein the intake filter is mounted to the rigid component.

19. The device of claim 18, wherein the intake filter filters the replacement air so as to block at least 95% of particles 0.3 microns or larger.

20. The device of claim 1, wherein the intake filter is located near the mouth of the user to improve acoustics within the mask and to facilitate better oral communication.
